(19) United States
(12) Patent Application Publication
(10) Pub. No.: US 2016/0313777 A1
(43) Pub. Date: Oct. 27, 2016

(54) System and Method for Dynamically Adjusting Power Supply Efficiency

(71) Applicant: Dell Products, LP, Round Rock, TX (US)

(72) Inventors: Dinesh K. Ragupathi, Round Rock, TX (US); Ashish Munjal, Round Rock, TX (US); Thomas F. Archer, Austin, TX (US); Binay A. Kuruvila, Cedar Park, TX (US)

(21) Appl. No.: 14/695,313

(22) Filed: Apr. 24, 2015

(51) Int. Cl. G06F 1/32

(52) U.S. Cl. CPC G06F 1/32; G06F 1/3234; G06F 1/3296

(57) ABSTRACT

Power efficiency peak shifting capability information is received from a power supply unit, the power supply unit providing power to a load. An operating condition of the power supply unit is determined. A command is issued directing the power supply unit to transition from a first efficiency profile to a second efficiency profile based on the capability information and further based on the operating condition.

### FIELD OF THE DISCLOSURE

This disclosure relates generally to information handling systems, and more particularly relates to dynamically adjusting power supply efficiency in information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, networking systems, and power supplies.

### BRIEF DESCRIPTION OF THE DRAWINGS

Embodiments incorporating teachings of the present disclosure are shown and described with respect to the drawings presented herein, in which:

FIG. 1 is a block diagram illustrating an information handling system having a power management control module to control a plurality of power supply units (PSUs) in accordance with a specific embodiment of the present disclosure;

FIG. 2 is a block diagram illustrating the power management control module of FIG. 1 in accordance with a specific embodiment of the present disclosure;

FIG. 3 is a graph illustrating power conversion efficiency profiles associated with a configurable PSU included at the information handling system of FIG. 1 in accordance with a specific embodiment of the present disclosure;

FIG. 4 is a graph illustrating power conversion efficiency profiles associated with another configurable PSU included at the information handling system of FIG. 1 in accordance with a specific embodiment of the present disclosure;

FIG. 5 is a flow diagram illustrating a method for configuring PSUs at the information handling system of FIG. 1 in accordance with a specific embodiment of the present disclosure;

FIG. 6 is a flow diagram illustrating a method for configuring PSUs at the information handling system of FIG. 1 in accordance with another embodiment of the present disclosure; and

FIG. 7 is a block diagram illustrating an information handling system in accordance with a specific embodiment of the present disclosure.

### DETAILED DESCRIPTION OF DRAWINGS

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings certainly can be utilized in this application.

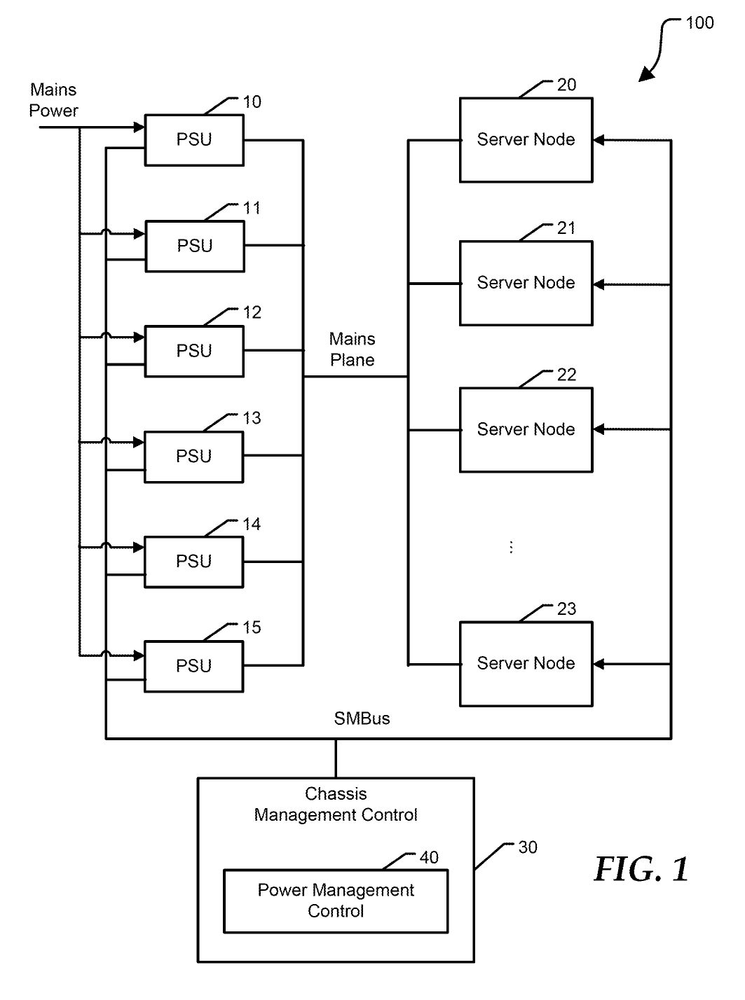

FIG. 1 shows an information handling system 100 in accordance with at least one embodiment of the present disclosure. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

For the purpose of illustration, information handling system 100 is described in an example context of a server chassis with multiple server blades. The techniques described herein can be applied in other information handling system contexts that utilize one or multiple power supply units (PSUs) without departing from the scope of the present disclosure.

Information handling system 100 includes a plurality of power supply units (PSUs), such as PSUs 10, 11, 12, 13, 14, and 15, server nodes 20, 21, 22, and 23, and a chassis management control module 30. CMC 30 is configured to monitor and control components of information handling system 100. For example, chassis management control module can activate and deactivate server nodes in response to a power conservation policy, computational requirements, and the like. CMC 30 includes a power management control module 40, which is configured to control operation of PSUs 10-15, and selectively engage and disengage PSUs based on current operating characteristics of information handling system 100 and in accordance with efficiency profiles associated with PSUs 10-15, described in greater detail below. A PSU is engaged when it is actively providing power to a load, such as information handling system 100. Conversely, a PSU is disengaged when it is not providing power to a load of the information handling system, such as in response to a failure of the PSU, or in response to an action by chassis management control module 30. Information handling system 100 may include other components in addition to those illustrated that also receive power from power delivery module 10.

As disclosed herein, one or more of PSUs 10-15 are capable of adjusting their energy conversion efficiency characteristics in response to commands received over a System Management Bus (SMBus) interface, a Power Management Bus (PMBus) interface, or the like. For example, power management control module 40 can determine an average power level being delivered by a PSU and adjust a power efficiency profile of the PSU so that the PSU operates at a more-optimal efficiency.

Each PSU of PSUs 10-15 has an input to receive electric power via a node labeled “MAINS POWER,” a bidirectional control interface terminal connected to a node labeled “SMBus,” and an output connected to a node labeled “POWER PLANE.” Each server node of server nodes 20-23 has an input to receive power from node POWER PLANE and a bidirectional control interface terminal connected to node SMBus. Chassis management control module 30 is connected to node SMBus. Node SMBus facilitates communication of information between components of information handling system 100 in accordance with an industry-standard SMBus serial interface protocol. For the purpose of example, six PSUs are illustrated at FIG. 1, however a greater or fewer number of PSUs can be included at information handling system 100.

In one embodiment, each PSU of PSUs 10-15 is compliant with a standard power-management protocol known as PMBus. The PMBus protocol is implemented over the SMBus protocol, and enables chassis management control module 30 to program, control, and conduct real-time monitoring of each PSU of PSUs 10-15. For example, power management control module 40 is configured to query each PSU of PSUs 10-15 to determine a peak efficiency shifting capability the PSU, an amount of mains power received at the input of a selected PSU via node MAINS POWER (power input), and to determine an amount of power provided to node POWER PLANE at the output of the selected PSU (power output). Based on this information, power management control module 40 can determine a power conversion efficiency of each PSU. Module 40 can also determine how much power each PSU is providing in relation to the rated power delivery capability of the PSU. While the PMBus protocol is used in this example, another standard or proprietary protocol can be used to implement communication between power management control module 40 and each PSU of PSUs 10-15.

As used herein, the term percentage of load (POL) is defined as a ratio of output power that is being delivered by a PSU to a load relative to the rated, name-plate, capability of the PSU, expressed as a percentage. For example, if a 1200 watt PSU is presently delivering 600 watt, the POL is (600/1200)×100, or 50%. In one embodiment, CMC 30 or power management control module 40 can issue commands to each PSU to determine whether the PSU includes dynamic efficiency adjusting capabilities, and if such capability is available, configure the PSU to shift its peak efficiency operating characteristics so as to reduce power demand of system 100. For example, module 40 can query a PSU and determine that the PSU can be configured to operate with a peak efficiency corresponding to POL values of either 40% or 50%, and is presently configured to operate at a POL of 50%. If module 40 determines that an average amount of power presently provided by the PSU is only 40% of the PSU's rate capability, module 40 can shift the operating efficiency profile of the PSU from 50% to 40%.

Each server node of server nodes 20-23 can include one or more data processing devices, such as a microprocessor or microcomputer, and each data processing device can include one or more processor cores. Each server node of server nodes 20-23 is operable to access computer-readable medium such as a memory device, which is capable of storing a software program that includes a set of instructions to manipulate at least one processor to perform desired tasks. A server node further can include memory devices, other information storage devices, peripheral interface devices, and the like. Furthermore, a server node can include one or more interfaces (not shown) to support communications and information transfer with another server node, or with other components of information handling system 100 such as shared information storage devices, peripheral interface devices, and the like (not shown at FIG. 1). The SMBus interface is an example of one such interface. In an embodiment, information handling system 100 may include a server rack, and server nodes 20-23 may each represent blade servers.

The amount of power consumed by a respective server node can vary in response to how the corresponding server node is configured, the selection and utilization of associated hardware components, and the type of computations being performed at the server node, amongst other factors. For example, chassis management control module 30 can place one or more server nodes into a power-conservation mode when demand for computational resources does not require the operation of all server nodes. In an embodiment, power management control module 40 can respond to current power demand of information handling system 100 and dynamically shift a peak operating efficiency of selected PSUs, or engage a selected number of PSUs based on information included at PSU efficiency profiles to improve the power conversion efficiency of power delivery module 10 in accordance with one or more embodiments of the present disclosure.

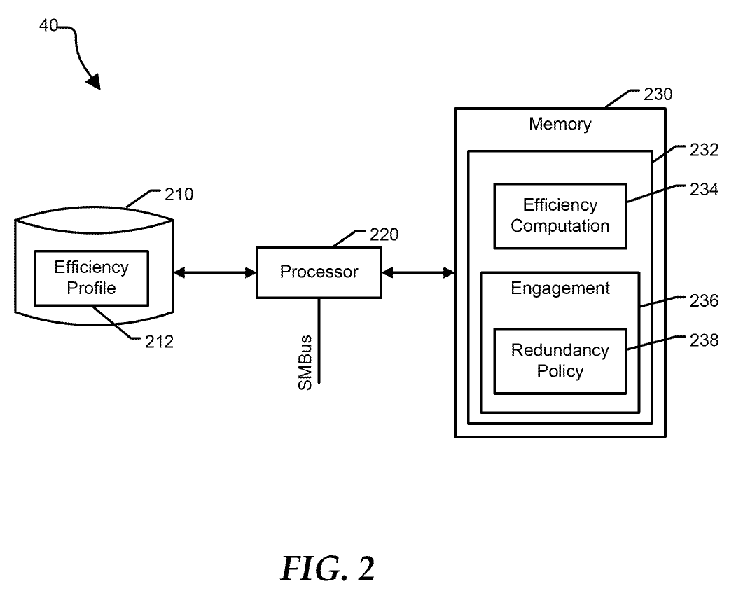

FIG. 2 is a block diagram illustrating power management control module 40 of FIG. 1 in accordance with a specific embodiment of the present disclosure. Power management control module 40 can be implemented using dedicated logic devices, by one or more processors configured to execute a software program, or a combination thereof. In the illustrated example at FIG. 2, power management control module 40 is implemented as one or more processors that execute instructions included in one or more software programs. In particular, power management control module 40 includes a storage component 210, one or more processors 220 or other data processing devices, and a memory device 230. Storage component 210 is configured to store a power conversion efficiency profile 212 in a data structure such as a file, a table, a linked list, or the like. Memory device 230 includes a software program 232, which includes an efficiency computation software module 234 and an engagement software module 236. Engagement software module 236 includes redundancy policy information 238 representative of the PSU redundancy policy to be implemented in information handling system 100.

Processor 220 includes a bidirectional control interface connected to node SMBus, a bidirectional data interface connected to storage component 210, and a bidirectional data interface connected to memory device 230. Processor 220 is operable to execute software program 232. Processor 220 may be a device that is dedicated to performing only tasks associated with power management control module 40, or it may perform additional processing tasks of information handling system 100.

Storage component 210 can include one or more registers included at data processing device 220, a non-volatile or volatile memory device, or another device operable to store one or more power conversion efficiency profiles, such as power conversion efficiency profile 212. Memory device 230 is configured to store software program 232, and may include a hard-disk drive, a random access memory (RAM), a read only memory (ROM), another type of data memory device, or a combination thereof. Furthermore, storage component 210 can be implemented using storage resources provided by memory device 230. Each of efficiency computation software module 234 and engagement software module 236 includes sets of instructions that can be executed by processor 220. In another embodiment, power management control module 40 can be partially or fully implemented in hardware using a state machine, hard-coded logic devices, and the like.

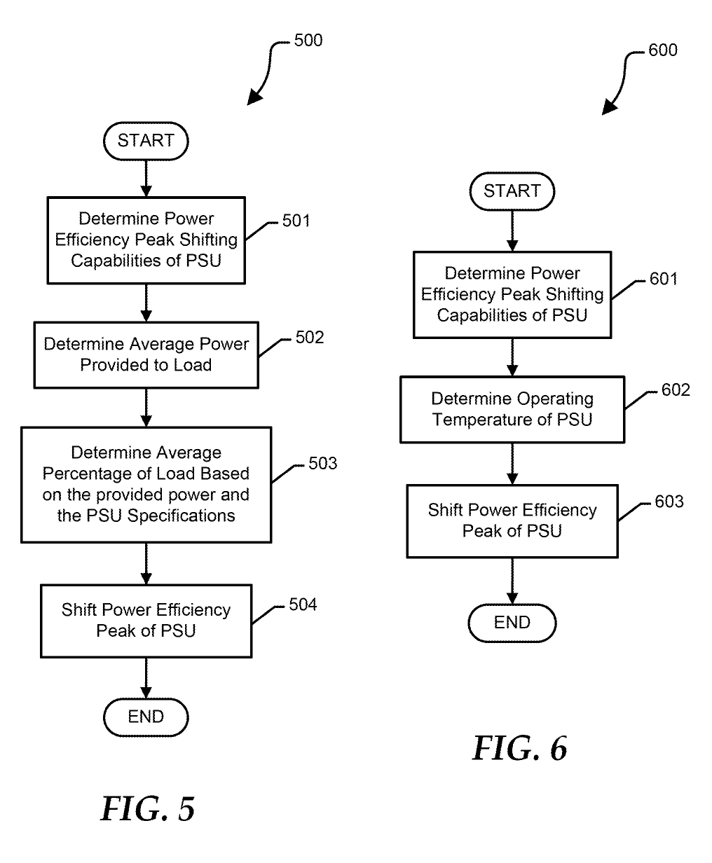

Power management control module 40 is configured to determine a respective power conversion efficiency profile representing power conversion efficiency characteristics of each corresponding PSU of PSUs 10-15 over a range of operating loads. During operation of information handling system 100, power management control module 40 can periodically request information from each PSU using the PMBus protocol conducted by node SMBus. For example, management control module 40 can issue a request to PSU 11 inquiring as to an amount of power currently being received by PSU 11, and a corresponding output power currently being provided by PSU 11. Based on this information, management control module 40 can calculate a power conversion efficiency of PSU 11 for the current operating load using the equation:

$$Efficiency = \frac{( Pin - Pout )}{Pin} \times 100 \qquad Eq . 1$$

where the variable Pin represents the power consumed by the PSU (power input), and the variable Pout represents the power provided at the output of the PSU (power output). Power management control module 40 can issue similar requests to each PSU of PSUs 10-15 and do so over a range of operating conditions (and an associated range of loads) to compile a power conversion efficiency profile corresponding to each PSU as described in greater detail with reference to FIG. 5.

In one embodiment, a power conversion efficiency profile of a PSU includes a set of data-pairs representative of the power conversion efficiencies of the PSU over a range of output loads or power outputs. In particular, the power conversion efficiency is calculated and expressed based on a quantity referred to as “percent-of-load.” Percent-of-load is a fraction, expressed as a percentage, quantifying the power provided by a PSU in relation to a maximum output power capability of the PSU:

$$Percent \text{-} of \text{-} load = \frac{{P}_{out}}{{P}_{max}} \times 100 \qquad Eq . 2$$

where the variable Pout represents the power provided at the output of the PSU (power output), and Pₘₐₓ represents the specified maximum output power that the PSU is capable of providing. For example, if the maximum output power of a PSU is 1000 watts, and the PSU is currently providing 400 watts of power, the percent-of-load is 40%. Thus, the power conversion efficiency profile of a PSU can include a respective power conversion efficiency corresponding to percent-of-load values ranging from approximately zero to 100% of percent-of-load. The efficiency profile information can be stored in a data structure at storage component 210.

Power management control module 40 is further configured to: 1) determine a total amount of power being supplied to information handling system 100; 2) determine an efficiency shifting capability of each PSU; 3) determine a number of PSUs needed to provide the total amount of power and a POL of each PSU that is engaged; and 4) configure a POL efficiency profile of each PSU so that each PSU is operating at a substantially optimal efficiency based on an amount of power provided by the PSU. The total amount of power to be supplied to information handling system 100 is the total amount of power currently being consumed by all components included at information handling system 100. Because power consumption can fluctuate in response to varying computational activity of servers 20-23, module 40 can collect periodic load measurements in order to calculate an average, steady state, load at each PSU. Module 40 can periodically repeat this process to maintain optimal efficiency as the total power consumed by system 100 changes over time.

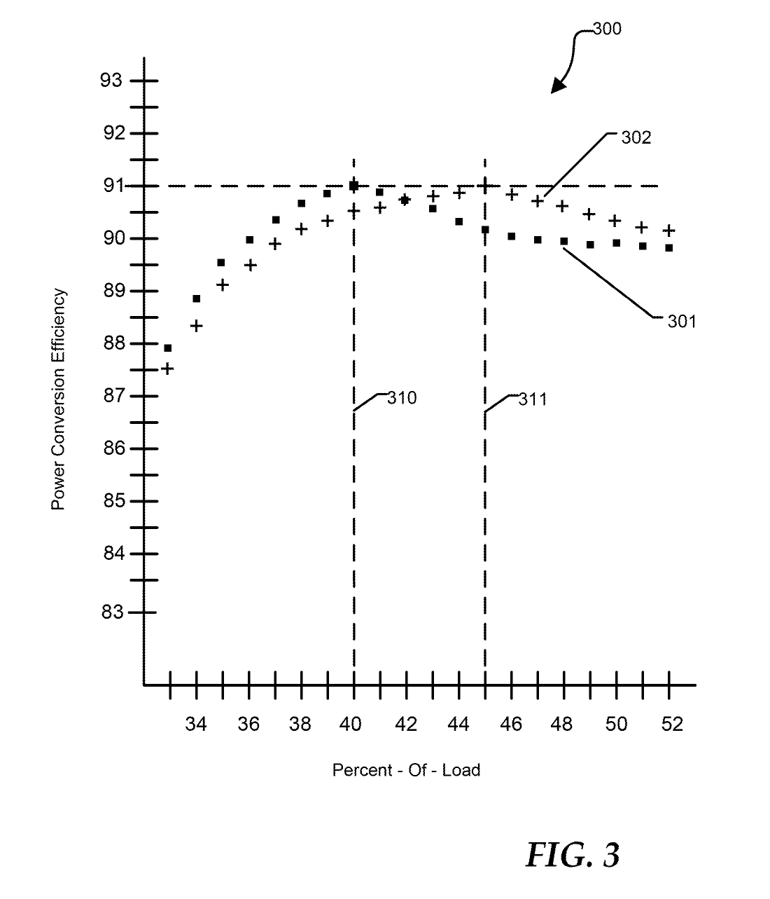

FIG. 3 is a graph 300 illustrating power conversion efficiency profiles associated with a configurable PSU included at the information handling system of FIG. 1 in accordance with a specific embodiment of the present disclosure. Graph 300 includes a horizontal axis representing percent-of-load, POL, and a vertical axis representing power conversion efficiency, expressed as a percentage. Graph 300 includes power conversion efficiency profiles 301 and 302 available at a representative PSU. A power conversion efficiency profile associates power conversion efficiency in relationship to a range of percent-of-load values. As illustrated by profile 301, the power conversion efficiency of a PSU can vary over a range of operating load, attaining a maximum efficiency at a POL of 40%, illustrated by reference 310. In comparison, profile 302 provides a maximum operating efficiency at a POL of 45%, illustrated by reference 311. In either case, conversion efficiency decreases for loads below and above the peak efficiency operating condition. It will be appreciated that a power conversion efficiency profile can include fewer, or a greater number of data points. During operation, power management control module 40 can issue a command to a PSU directing the PSU to transition operation from one efficiency profile to another efficiency based on current operating conditions at system 100. For example, if a PSU is currently configured to operate according to efficiency profile 301, but loading on the PSU had increased to a POL of 45%, module 40 can command the PSU to transition operation to efficiency profile 302, thereby increasing operating efficiency of the PSU by approximately 1%.

One of skill will appreciate that efficiency profiles 301 and 302 are merely examples of possible PSU behavior, and the shape of the data curves can vary based on numerous circuit and design characteristics. Power supply efficiency is known to be variable based on many factors, including but not limited to power conversion circuitry, such as transformers, transistors, and other discrete components, inlet temperature, input voltage, switching frequency, and the like. Accordingly, a PSU can be configured to provide alternate efficiency profiles, such as efficiency profiles 301 and 302, by manipulating one or more of these components or parameters. While two efficiency profiles are illustrated at FIG. 3, it will be appreciated that more than two profiles can be provided.

In one embodiment, information characterizing profiles 301 and 302 can be provided by a manufacturer of a PSU and stored at a memory device included at the PSU. The efficiency profile can be accessed by issuing a command provided to the PSU via the PMBus interface. In an embodiment, a single power conversion efficiency profile can be determined and used to represent one or more of multiple PSUs of identical or similar construction. For example, if information handling system 100 includes six similar PSUs, a single power conversion efficiency profile can be prepared and used to represent each of the six PSUs.

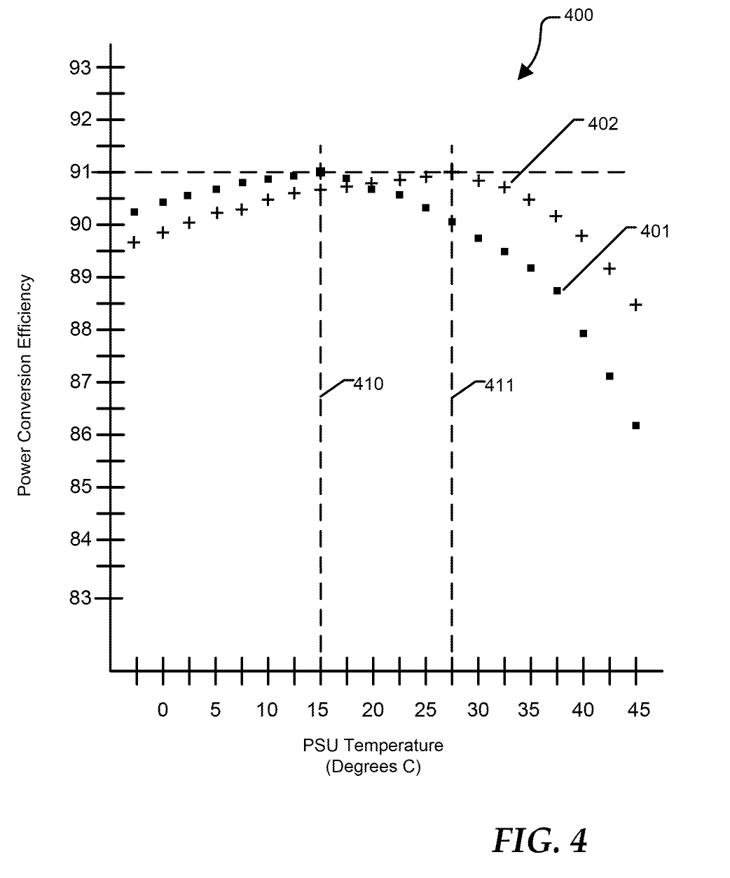

FIG. 4 is a graph 400 illustrating power conversion efficiency profiles associated with another configurable PSU included at the information handling system of FIG. 1 in accordance with a specific embodiment of the present disclosure. Graph 400 includes a horizontal axis representing temperature at the PSU, and a vertical axis representing power conversion efficiency, expressed as a percentage. Graph 400 includes power conversion efficiency profiles 401 and 402 available at a representative PSU. At FIG. 4, a power conversion efficiency profile associates power conversion efficiency in relationship to an operating temperature of the PSU. As illustrated by profile 401, the power conversion efficiency of a PSU can vary over a range of operating temperature, attaining a maximum efficiency at a temperature of 15° C., illustrated by reference 410. In comparison, profile 402 provides a maximum operating efficiency at a temperature of 27.5° C. Power management control module 40 can issue commands to the PSU to inquire whether a PSU provides efficiency shifting capabilities, access profile information, and direct the PSU to transition operation from one efficiency profile to another profile. For example, if a PSU is currently configured to operate according to efficiency profile 401, but an operating temperature at the PSU has increased to approximately 27° C. or higher, module 40 can command the PSU to transition operation to efficiency profile 402, thereby increasing operating efficiency of the PSU.

One of skill will appreciate that percentage of load and temperature are two examples of operating conditions of a PSU, and that efficiency profiles can be associated with other operating conditions, such as air flow, humidity, barometric pressure, mains voltage, and the like.

FIG. 5 is a flow diagram illustrating a method 500 for configuring PSUs 10-15 at information handling system 100 of FIG. 1 in accordance with a specific embodiment of the present disclosure. Method 500 begins at block 501 where power efficiency peak shifting capabilities of PSUs is determined. For example, power management control module 40 can issue commands to each of PSUs 10-15 inquiring as to whether each PSU has the ability to configure alternate energy conversion efficiencies based on a level of power being provided by each PSU. Module 40 can further access efficiency profiles available at each PSU. The method continues at block 502 where an average power provided to a load is determined. For example, module 40 can issue a command to one or more PSUs of PSUs 10-15 requesting the PSU to measure a power level currently being provided by the PSU. This measurement typically corresponds to an average value over a short period of time, such as fifty milliseconds. Module 40 can make repeated inquiries over longer periods of time, e.g. minutes or hours, to determine a steady-state average power delivery level of the PSU.

The method continues at block 503 where an average percentage of load is determined based on the current power level provided by the PSU and based on the PSU's total power capability. For example, if a PSU that is rated for 1800 watts that is presently providing 1000 watts, the average POL is (1000/1800)×100, or approximately 56%. The method proceeds to block 504 where a power efficiency peak of a PSU is shifted from one efficiency profile to another profile. For example, module 40 can determine that the PSU can operate more efficiently, given the present load conditions, at an alternate efficiency profile. Module 40 can issue a command directing the PSU to transition operation to the alternate profile.

FIG. 6 is a flow diagram illustrating a method 600 for configuring PSUs 10-15 at information handling system 100 of FIG. 1 in accordance with another embodiment of the present disclosure. Method 600 is similar to method 500, except efficiency profiles provided by an exemplary PSU specify energy conversion efficiency as a function of operating temperature instead of POL. Method 600 begins at block 601 where power efficiency peak shifting capabilities of PSUs is determined. For example, power management control module 40 can issue commands to each of PSUs 10-15 inquiring as to whether each PSU has the ability to configure alternate energy conversion efficiencies based on an operating temperature of each PSU. Module 40 can further access efficiency profiles available at each PSU. The method continues at block 602 where an operating temperature of a PSU is determined. For example, module 40 can issue a command to the PSU inquiring as to the current temperature of the PSU. Alternatively, system 100 can include thermal sensors proximate to PSUs 10-15 and CMC 30 or module 40 can monitor these sensors to determine a current temperature at each PSU. The method continues at block 603 where a power efficiency peak of a PSU is shifted from one efficiency profile to another profile. For example, module 40 can determine that one or more of PSUs 10-15 can operate more efficiently if configured to operate at an alternate efficiency profile, based on a present configuration and based on the present operating temperature.

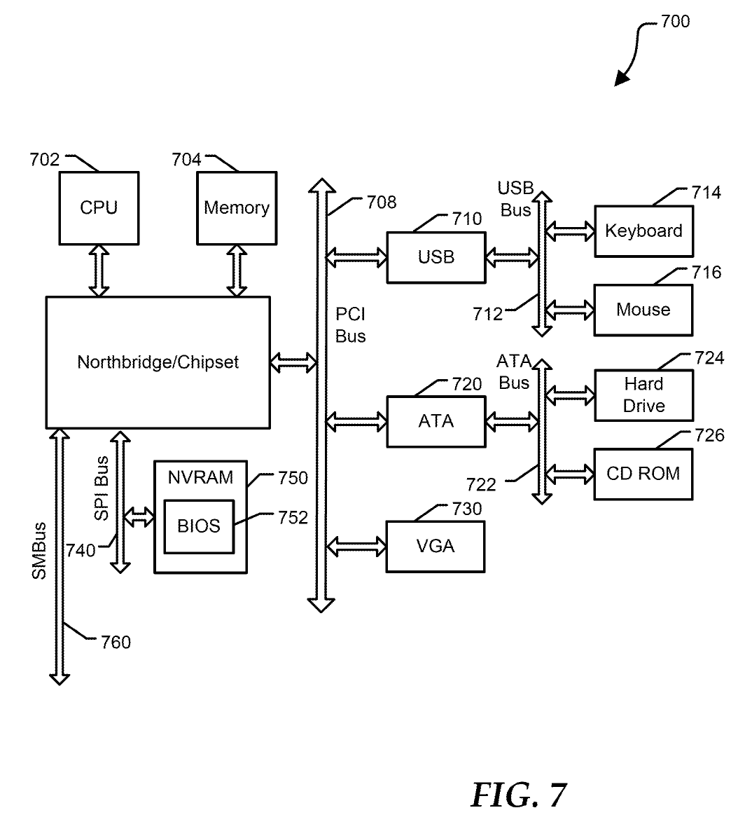

FIG. 7 illustrates an information handling system 700 including according to a specific embodiment of the present disclosure. For example, system 700 can represent each of server nodes 20-23, CMC 30, or power management control module 40. System 700 includes a processor 702, a memory 704, a northbridge/chipset 706, a PCI bus 708, a universal serial bus (USB) controller 710, a USB 712, a keyboard device controller 714, a mouse device controller 716, an ATA bus controller 720, an ATA bus 722, a hard drive device controller 724, a compact disk read only memory (CD ROM) device controller 726, a video graphics array (VGA) device controller, a serial peripheral interface (SPI) bus 740, and a non-volatile random access memory (NVRAM) 750 for storing a basic input/output system (BIOS) 752. SMBus 760 provides communication between a motherboard, including the above components, and chassis management components, including power supplies, and the like. Information handling system 700 can include additional components and additional busses, not shown for clarity. For example, system 700 can include multiple processor cores, one or more network interface controllers (NICs), and the like. While a particular arrangement of bus technologies and interconnections is illustrated for the purpose of example, one of skill will appreciate that the techniques disclosed herein are applicable to other system architectures. In one embodiment, portions of northbridge/chipset 706 can be integrated within CPU 702.

Information handling system 700 can include one or more storage devices that can store machine-executable code, one or more communications ports for communicating with external devices, and various input and output (I/O) devices, such as a keyboard, a mouse, and a video display. An example of information handling system 700 includes a multi-tenant chassis system where groups of tenants (users) share a common chassis and each of the tenants has a unique set of resources assigned to them. The resources can include blade servers of the chassis, input/output (I/O) modules, Peripheral Component Interconnect-Express (PCIe) cards, storage controllers, and the like

Information handling system 700 can include a set of instructions that can be executed to cause the information handling system to perform any one or more of the methods or computer based functions disclosed herein. The information handling system 700 may operate as a standalone device or may be connected to other computer systems or peripheral devices, such as by a network.

In a networked deployment, the information handling system 700 may operate in the capacity of a server or as a client user computer in a server-client user network environment, or as a peer computer system in a peer-to-peer (or distributed) network environment. The information handling system 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 700 is illustrated, the term “system” shall also be taken to include any collection of systems or sub-systems that individually or jointly execute a set, or multiple sets, of instructions to perform one or more computer functions.

The information handling system 700 can include a disk drive unit and may include a computer-readable medium, not shown in FIG. 7, in which one or more sets of instructions, such as software, can be embedded. Further, the instructions may embody one or more of the methods or logic as described herein. In a particular embodiment, the instructions may reside completely, or at least partially, within system memory 104 or another memory included at system 700, and/or within the processor 702 during execution by the information handling system 700. The system memory 704 and the processor 702 also may include computer-readable media. A network interface device (not shown at FIG. 1) can provide connectivity to a network, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal; so that a device connected to a network can communicate voice, video or data over the network. Further, the instructions may be transmitted or received over the network via the network interface device.

The term “computer-readable medium” can include a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. In a particular non-limiting, exemplary embodiment, the computer-readable medium can include a solid-state memory such as a memory card or other package that houses one or more non-volatile read-only memories.

Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
receiving power efficiency peak shifting capability information from a power supply unit (PSU);
determining an operating condition of the PSU; and
directing the PSU to transition from a first efficiency profile to a second efficiency profile based on the capability information and further based on the operating condition.

2. The method of claim 1, wherein the operating condition is an average amount of power that is provided by the PSU to a load.

3. The method of claim 1, wherein the operating condition is a temperature of the PSU.

4. The method of claim 1, wherein the capability information includes a power conversion efficiency profile representing power conversion efficiencies of the PSU relative to the operating condition.

5. The method of claim 4, wherein the efficiency profile specifies energy conversion efficiency of the PSU relative to an amount of power provided by the PSU.

6. The method of claim 5, wherein the power provided by the PSU is expressed as a ratio of the power provided by the PSU relative to a maximum power delivery capability of the PSU.

7. The method of claim 4, wherein the efficiency profile specifies energy conversion efficiency of the PSU relative to an operating temperature of the PSU.

8. The method of claim 4, wherein the first and second efficiency profiles are stored at the PSU.

9. The method of claim 4, wherein the first and second efficiency profiles are stored at a memory device external to the PSU

10. The method of claim 1, further comprising directing the PSU to provide a measurement of a current amount of power being provided by the PSU.

11. The method of claim 1, wherein transitioning operation from the first profile to the second profile is to reduce an amount of power consumed at an input of the PSU.

12. A system comprising:
a data processing device;
a power supply unit (PSU) to provide power to the data processing device; and
a power control device to:
receive power efficiency peak shifting capability information from the PSU;
determine an operating condition of the PSU; and
direct the PSU to transition from a first efficiency profile to a second efficiency profile based on the capability information and further based on the operating condition.

13. The system of claim 12, wherein the operating condition is an average amount of power that is provided by the PSU to a load.

14. The system of claim 12, wherein the operating condition is a temperature of the PSU.

15. The system of claim 12, wherein the capability information includes a power conversion efficiency profile representing power conversion efficiencies of the PSU relative to the operating condition.

16. The system of claim 15, wherein the efficiency profile specifies energy conversion efficiency of the PSU relative to an amount of power provided by the PSU.

17. The system of claim 15, wherein the efficiency profile specifies energy conversion efficiency of the PSU relative to an operating temperature of the PSU.

18. The system of claim 15, wherein the first and second efficiency profiles are stored at the PSU.

19. A computer-readable medium storing a software program, the software program comprising a set of instructions to manipulate at least one processor to:
receive power efficiency peak shifting capability information from a power supply unit (PSU);
determine an operating condition of the PSU; and
command the PSU to transition from a first efficiency profile to a second efficiency profile based on the capability information and further based on the operating condition.

20. The computer-readable medium of claim 19, wherein the operating condition is an average amount of power that is provided by the PSU to a load, and the capability information includes a power conversion efficiency profile representing power conversion efficiencies of the PSU relative to an amount of power provided by the PSU.
